(19) United States
(12) Patent Application Publication
(10) Pub. No.: US 2007/0137672 A1
(43) Pub. Date: Jun. 21, 2007

(54) Spin cleaning apparatus and wafer cleaning method

(75) Inventors: Makoto Sasaki, Kawasaki (JP); Tsukasa Itani, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/393,683

(22) Filed: Mar. 31, 2006

(30) Foreign Application Priority Data
Dec. 19, 2005 (JP) 2005-364461

(51) Int. Cl. B08B 3/12; B08B 7/00; C23G 1/00; B08B 3/00

(52) U.S. Cl. 134/2; 134/1; 134/33; 134/184; 134/149; 134/137

(57) ABSTRACT

To provide a wafer cleaning method capable of restricting breakage of fine structures disposed on a wafer, and a spin cleaning apparatus enabling such cleaning. The spin cleaning apparatus injects a cleaning liquid on a wafer surface while moving a nozzle, and at the same time, with an ultrasonic wave generated inside the nozzle, irradiates a cleaning liquid collision spot, thereby cleaning the wafer surface. The above apparatus includes at least one of the following functions: (1) a function of varying the rotation frequency of the wafer; (2) a function of varying the traveling speed of the nozzle in the direction parallel to the wafer; (3) a function of varying the output of the ultrasonic wave; and (4) a function of varying the distance between the nozzle and the cleaning liquid collision spot, all corresponding to the position of the cleaning liquid collision spot on the wafer.

### CROSS-REFERENCE TO RELATED APPLICATIONS

This application is based upon and claims the benefit of priority from the prior Japanese Patent Application No. 2005-364461, filed on Dec. 19, 2005, the entire contents of which are incorporated herein by reference.

### BACKGROUND OF THE INVENTION

1. Field of the Invention

The present invention relates to a sheet-fed spin cleaning apparatus and a wafer cleaning method for use in a process of manufacturing semiconductor devices, for cleaning a wafer by injecting a cleaning liquid, such as ultrapure water, from a nozzle onto a wafer surface while rotating the wafer to be cleaned, moving the nozzle, and at the same time, irradiating the wafer with an ultrasonic wave produced inside the nozzle via the cleaning liquid in the capacity of an intermediary.

2. Description of the Related Art

In the spin cleaning technique with ultrasonic cleaning, a cleaning liquid is injected from a nozzle onto the wafer surface, and at the same time, an ultrasonic wave is generated by oscillating an ultrasonic vibrator disposed inside the nozzle. Further, the ultrasonic wave is propagated onto the wafer surface via the cleaning liquid in the capacity of an intermediary. Thus, the surface of a wafer is cleaned by using the ultrasonic energy. In a small area of the wafer surface with which the cleaning liquid injected from the nozzle collides (hereafter, the above small area is referred to as a “cleaning liquid collision spot”), the ultrasonic wave acts most intensively. In the present invention, the above action is expressed as “irradiating a cleaning liquid collision spot with ultrasonic wave generated inside the nozzle”.

The above state is exemplarily illustrated using FIGS. 1, 2 and 3. FIG. 1 shows a schematic perspective view illustrating spin cleaning with irradiation with an ultrasonic wave. In FIG. 1, a wafer 1 rotates about the center axis 2 of the wafer disc. A cleaning liquid 5 is injected from a nozzle 3 having a built-in ultrasonic vibrator (not shown) toward a wafer surface 4, so as to clean the wafer. Symbol 6 is the cleaning liquid collision spot.

FIG. 2 shows a schematic plan view, viewed from right above the wafer shown in FIG. 1. In this figure, the nozzle is omitted so that the cleaning liquid collision spot 6 can be viewed. Arrows 7 represent the direction of rotation of the wafer 1. By moving an arm 8, the nozzle 3 reciprocates in the direction shown by an arrow 9. Thus, the cleaning liquid collision spot traces an arc-shaped locus passing through the center of the wafer. As a known example, Japanese Unexamined Patent Application Publication No. Hei 10-308374 (FIGS. 2 through 4) may be listed.

In FIG. 3, differently from FIG. 2, a nozzle reciprocates along a linear guide, so that the cleaning liquid collision spot 6 travels along a line passing through the center of the wafer.

By rotating the wafer while operating the above mechanisms, the cleaning liquid collision spot passes throughout the whole areas of the wafer surface, and thereby the whole points on the wafer can be cleaned by the actions of the ultrasonic wave and the cleaning liquid.

When performing ultrasonic cleaning of a wafer having fine structures such as extremely fragile patterns formed thereon, there are cases in which the fine structures are bent or lost by the damage given by the ultrasonic wave, resulting in breakage of the wafer. In particular, ultrasonic wave cleaning using a spin cleaning apparatus may frequently result in the phenomenon of fine structures such as patterns being broken at particular positions of the wafer.

### SUMMARY OF THE INVENTION

In order to solve the above-mentioned problem, it is an object of the present invention to provide a wafer cleaning method capable of suppressing damages of fine structures on a wafer, and a spin cleaning apparatus enabling such cleaning.

According to one aspect of the present invention, there is provided a spin cleaning apparatus for cleaning a wafer surface by rotating the wafer to be cleaned, injecting a cleaning liquid from a nozzle onto the wafer surface while moving the nozzle, and at the same time, with an ultrasonic wave generated inside the nozzle, irradiating a cleaning liquid collision spot, a point of the wafer surface with which the cleaning liquid injected from the nozzle collides, via the cleaning liquid in the capacity of an intermediary. The above spin cleaning apparatus includes at least one of the following functions:

(1) Corresponding to the position of the cleaning liquid collision spot on the wafer, a function of varying the rotation frequency (that is, number of rotation) of the wafer.

(2) Corresponding to the position of the cleaning liquid collision spot on the wafer, a function of varying the traveling speed of the nozzle in the direction parallel to the wafer.

(3) Corresponding to the position of the cleaning liquid collision spot on the wafer, a function of varying the output of the ultrasonic wave.

(4) Corresponding to the position of the cleaning liquid collision spot on the wafer, a function of varying the distance between the nozzle and the cleaning liquid collision spot.

According to the above-mentioned aspect, it is possible to realize a spin cleaning apparatus capable of cleaning, while suppressing breakage of the fine structures disposed on the wafer.

It is preferable to include: at least two of the above functions (1) to (4); at least one of the above functions (3) and (4); at least one of the functions (3) and (4), and at least one of the functions (1) and (2); as well as the capability of setting the rotation frequency of the wafer so as to decrease it in proportion as the cleaning liquid collision spot moves away from the center of the wafer; the capability of setting the traveling speed of the cleaning liquid collision spot in the direction parallel to the wafer so as to decrease it in proportion as the cleaning liquid collision spot moves away from the center of the wafer; the capability of setting the output of the ultrasonic wave so as to increase it in proportion as the cleaning liquid collision spot moves away from the center of the wafer; the capability of setting the output of the ultrasonic wave so as to realize a varied output of the ultrasonic wave by adjusting an on/off time of the output of the ultrasonic wave; the capability of setting the distance between the nozzle and the cleaning liquid collision spot so as to decrease it in proportion as the cleaning liquid collision spot moves away from the center of the wafer; the capability of setting the elevation angle of the nozzle so as to vary the distance between the nozzle and the cleaning liquid collision spot by varying the elevation angle of the nozzle at the cleaning liquid collision spot; and the capability of setting the distance between the nozzle and the wafer surface so as to vary the distance between the nozzle and the cleaning liquid collision spot by varying the distance between the nozzle and the wafer surface.

According to another aspect of the present invention, a wafer cleaning method for cleaning a wafer surface is provided. The method includes rotating the wafer to be cleaned, injecting a cleaning liquid from a nozzle onto the wafer surface while moving the nozzle, and at the same time, with an ultrasonic wave generated inside the nozzle, irradiating a cleaning liquid collision spot, a point of the wafer surface with which the cleaning liquid injected from the nozzle collides, via the cleaning liquid in the capacity of an intermediary. The method further includes at least one of the following actions (A) to (D):

(A) Corresponding to the position of the cleaning liquid collision spot on the wafer, varying the rotation frequency of the wafer.

(B) Corresponding to the position of the cleaning liquid collision spot on the wafer, varying the traveling speed of the nozzle in the direction parallel to the wafer.

(C) Corresponding to the position of the cleaning liquid collision spot on the wafer, varying the output of the ultrasonic wave.

(D) Corresponding to the position of the cleaning liquid collision spot on the wafer surface, varying the distance between the nozzle and the cleaning liquid collision spot.

According to the above aspect, it is possible to realize a cleaning method capable of suppressing breakage of fine structures disposed on the wafer.

It is preferable to perform at least two of the above (A) to (D); to perform at least one of the above (C) and (D); to perform at least one of (C) and (D) and at least one of (A) and (B); to decrease the rotation frequency of the wafer, in proportion as the cleaning liquid collision spot moves away from the center of the wafer; to decrease the traveling speed of the cleaning liquid collision spot in the direction parallel to the wafer, in proportion as the cleaning liquid collision spot moves away from the center of the wafer; to increase the output of the ultrasonic wave, in proportion as the cleaning liquid collision spot moves away from the center of the wafer; to realize a varied output of the ultrasonic wave by adjusting an on/off time of the output of the ultrasonic wave; to decrease the distance between the nozzle and the cleaning liquid collision spot, in proportion as the cleaning liquid collision spot moves away from the center of the wafer; to vary the distance between the nozzle and the cleaning liquid collision spot, by varying the elevation angle of the nozzle at the cleaning liquid collision spot; to vary the distance between the nozzle and the cleaning liquid collision spot, by varying the distance between the nozzle and the wafer surface; and to use either of the above-mentioned spin cleaning apparatuses.

According to the present invention, it is possible to realize a spin cleaning method capable of suppressing breakage of fine structures disposed on a wafer, and a spin cleaning apparatus enabling such cleaning.

Other objects and features of the present invention will be more apparent by the following description of the embodiments.

### BRIEF DESCRIPTION OF THE DRAWINGS

FIG. 1 shows a schematic perspective view illustrating a state of spin cleaning with irradiation of an ultrasonic wave;

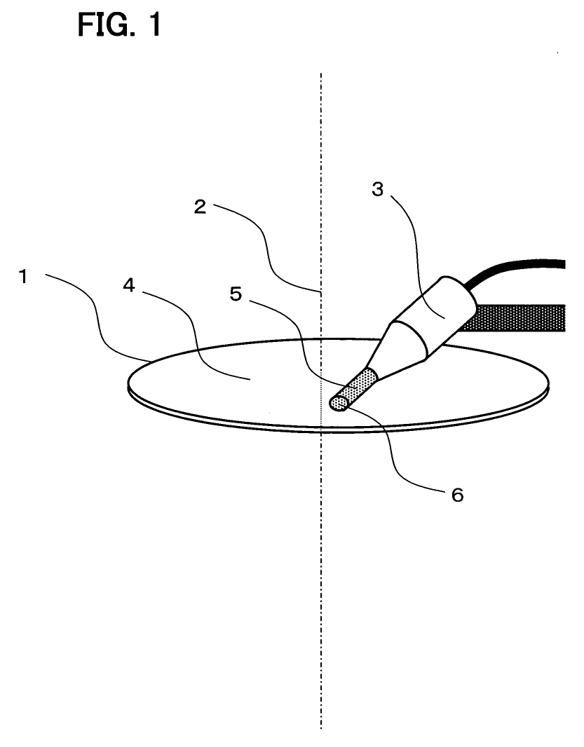

FIG. 2 shows a plan view of a wafer illustrating a movement of the cleaning liquid collision spot on the wafer;

FIG. 3 shows a plan view of a wafer illustrating another movement of the cleaning liquid collision spot on the wafer;

FIG. 4 shows a diagram illustrating the relationship between the distance from the center of a wafer and a linear velocity of the cleaning liquid collision spot;

FIG. 5 shows a chart illustrating the relationship between the position of a cleaning liquid collision spot and the rotation frequency of the wafer in example 2;

FIG. 6 shows a chart illustrating the relationship between the position of a cleaning liquid collision spot and the traveling speed of the cleaning liquid collision spot in example 2;

FIG. 7 shows a diagram illustrating changing of the elevation angle of a nozzle at the cleaning liquid collision spot;

FIG. 8 shows an explanation diagram illustrating a state of irradiation with a pulse-shaped ultrasonic wave;

FIG. 9 shows a plan view of a Si wafer illustrating patterns on the Si wafer, used in the examples and the comparative example; and

FIG. 10 shows a side view (cross-sectional view) of a Si wafer illustrating patterns on the Si wafer, used in the examples and the comparative example.

### DETAILED DESCRIPTION OF THE PREFERRED EMBODIMENTS

The preferred embodiment of the present invention is described hereinafter referring to the charts, tables, examples and drawings. However, it is to be understood that the present invention is not limited to the charts, tables, examples and drawings as well as the explanation. It goes without saying that other embodiments can be included in the category of the present invention, as long as they conform to the gist of the present invention. In the following figures, the same numeral refers to the same element.

As a result of a detailed survey, it has been found that a highly frequent occurrence of breakage of fine structures at particular points of a wafer is caused by the following reasons.

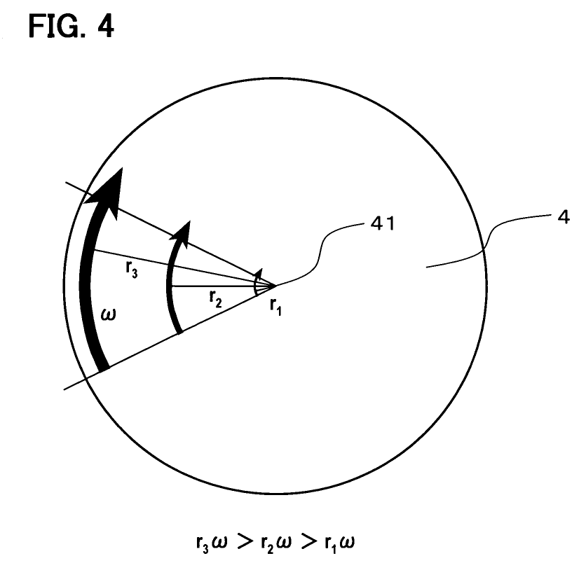

First, the breakage is caused by the difference in the traveling speed of the cleaning liquid collision spot on the wafer. When the wafer is rotated at a constant angular velocity ω, the traveling speed of the cleaning liquid collision spot on the wafer (a linear velocity rω of the movement of the cleaning liquid collision spot in the circumferential direction of the wafer) increases, as shown in FIG. 4, in proportion to the distance r from the center 41 of the wafer (shown by r1, r2 and r3 in FIG. 4).

Therefore, for example, when the cleaning liquid collision spot reciprocates between the center and a circumference portion of the wafer at a constant speed, in proportion as the cleaning liquid collision spot moves away from the rotation center of the wafer (namely, moves toward the peripheral direction), the time period in which a point on the wafer surface stays in the cleaning liquid collision spot becomes shorter. In other words, as a point is positioned nearer to the center of the wafer, the point stays in the cleaning liquid collision spot for a longer time, by which a larger amount of ultrasonic wave irradiation is received. This is considered to be one reason of the highly frequent occurrence of breakage of fine structures, in proportion as the point is positioned nearer to the center of the wafer. Therefore, to solve the above problem, it is considered important to make uniform the time periods in which points on the wafer surface stay in the cleaning liquid collision spot, respectively.

The second reason is that there are moments in which the cleaning liquid collision spot stays stationary on the wafer. When the reciprocal movement is given to a nozzle with a mechanical structure, moments of the nozzle staying in a stationary state occur at times the movement direction of the nozzle is changed. This is caused by a certain amount of allowance inevitably present in any mechanical structure. As a result, moments in which the cleaning liquid collision spot on the wafer stays stationary are produced. A position on the wafer passing through the cleaning liquid collision spot while the cleaning liquid collision spot is in a stationary state stays in the cleaning liquid collision spot longer than other positions. As a result, the position receives the ultrasonic wave irradiation for a longer time. This is considered to be another reason of highly frequent occurrence of the fine structures being broken at particular positions on the wafer. Accordingly, in order to solve the above problem, it is also considered important to make uniform the periods in which points on the wafer surface stay in the cleaning liquid collision spot, respectively.

Here, in the present invention, the above-mentioned ‘making uniform’ includes that the differences of the periods in which points on the wafer surface stay in the cleaning liquid collision spot respectively, are reduced on average, partially or wholly. Here, “to reduce partially” includes shortening the staying periods which are peculiarly long, such as a case caused by the mechanical allowance described later.

Taking the above study result into consideration, in the spin cleaning apparatus according to the present invention, the wafer to be cleaned is rotated, and a cleaning liquid is injected from a nozzle onto the wafer surface while the nozzle is being moved, and at the same time, a cleaning liquid collision spot, which is a point of the wafer surface with which the cleaning liquid injected from the nozzle collides, is irradiated with an ultrasonic wave generated inside the nozzle via the cleaning liquid in the capacity of an intermediary, and thereby the wafer surface is cleaned. In addition, at least one of the following functions is provided:

(1) Corresponding to the position of the cleaning liquid collision spot on the wafer, a function of varying the rotation frequency of the wafer.

(2) Corresponding to the position of the cleaning liquid collision spot on the wafer, a function of varying the traveling speed of the nozzle in the direction parallel to the wafer.

(3) Corresponding to the position of the cleaning liquid collision spot on the wafer, a function of varying the output of the ultrasonic wave.

(4) Corresponding to the position of the cleaning liquid collision spot on the wafer surface, a function of varying the distance between the nozzle and the cleaning liquid collision spot.

Preferably, at the time of cleaning, at least one of the following settings: (1)′ to (4)′ is possible. In the following description, ‘traveling speed’ does not mean a relative speed between the nozzle (or the cleaning liquid collision spot) and the wafer surface, but means a traveling speed based on the whole system.

(1)′ Corresponding to the position of the cleaning liquid collision spot on the wafer, automatically varying the rotation frequency of the wafer.

(2)′ Corresponding to the position of the cleaning liquid collision spot on the wafer, automatically varying the traveling speed of the nozzle in the direction parallel to the wafer.

(3)′ Corresponding to the position of the cleaning liquid collision spot on the wafer, automatically varying the output of the ultrasonic wave.

(4)′ Corresponding to the position of the cleaning liquid collision spot on the wafer, automatically varying the distance between the nozzle and the cleaning liquid collision spot.

Further, in the wafer cleaning method according to the present invention, when cleaning a wafer surface by rotating the wafer to be cleaned, injecting a cleaning liquid from a nozzle onto the wafer surface while moving the nozzle, and at the same time, with an ultrasonic wave generated inside the nozzle, irradiating a cleaning liquid collision spot, which is a point of the wafer surface with which the cleaning liquid injected from the nozzle collides, via the cleaning liquid in the capacity of an intermediary, at least one of the following actions (A) to (D) is performed:

(A) Corresponding to the position of the cleaning liquid collision spot on the wafer, varying the rotation frequency of the wafer.

(B) Corresponding to the position of the cleaning liquid collision spot on the wafer, varying the traveling speed of the nozzle in the direction parallel to the wafer.

(C) Corresponding to the position of the cleaning liquid collision spot on the wafer, varying the output of the ultrasonic wave.

(D) Corresponding to the position of the cleaning liquid collision spot on the wafer, varying the distance between the nozzle and the cleaning liquid collision spot.

It may be possible to newly design a spin cleaning apparatus having the above-mentioned functions. However, by modifying a known spin cleaning apparatus, it is also possible to obtain a spin cleaning apparatus having the above functions. Regarding functions other than those described above, there is no particular restriction, and any known functions may be included in the spin cleaning apparatus. The method adopted in the above spin cleaning apparatus is called a sheet-fed method, in which wafers are generally cleaned one sheet by one. However, as long as not departing from the spirit of the present invention, it may be possible to adopt any other methods, such as a method for simultaneously cleaning a plurality of wafer sheets.

Also, in the above-mentioned wafer cleaning method, although the above spin cleaning apparatus may be used, it is also possible to use other known cleaning apparatuses, or apparatuses modified therefrom, as long as the method of the present invention can be realized.

Also, there is no particular restriction to the type and size of the wafer, as well as the type, size and number of the nozzle(s). Regarding the cleaning liquid, there is also no restriction. Ultrapure water may often be used.

There is no particular restriction to the ultrasonic wave generation apparatus for generating ultrasonic waves, and any known apparatuses may be used properly. The energy used for the ultrasonic wave may be selected depending on the actual situation. Usually, apparatuses generating 100 Watts or less are used. In order to irradiate the cleaning liquid collision spot with the ultrasonic wave generated inside the nozzle via the cleaning liquid in the capacity of an intermediary, it is possible to use an ultrasonic wave vibrator provided inside the nozzle, which is a component for generating ultrasonic waves in an ultrasonic wave generation apparatus.

In the present invention, when “the position of a cleaning liquid collision spot on the wafer” is used as a basis, the actual position of the cleaning liquid collision spot on the wafer may be used. However, the position of the cleaning liquid collision spot on the wafer itself varies depending on the nozzle position, the injection direction from the nozzle, and the degree of spreading of the injected cleaning liquid. Therefore, in stead of the above basis, it is also possible to use, for example, the nozzle position on the wafer (the nozzle position projected on the wafer surface when the wafer surface is viewed perpendicularly), or further, if necessary, the nozzle position on the wafer appropriately corrected for the nozzle injection direction and the degree of spreading of the cleaning liquid. The description of “the position of the cleaning liquid collision spot on the wafer” according to the present invention includes substituting such a nozzle position on the wafer as mentioned above. In this sense, hereafter, descriptions regarding the ‘cleaning liquid collision spot’ may also be understood as the descriptions regarding the nozzle, as long as no contradiction lies in the context.

Accordingly, when performing any operation correspondingly to the position of the cleaning liquid collision spot on the wafer is required, this “any operation” may be performed correspondingly to the nozzle position on the wafer as described above, in practice. In such a case, although the nozzle position on the wafer may be directly related to the nozzle operation, it is also possible to indirectly relate the nozzle position on the wafer to other operations (for example, varying the rotation frequency of the wafer) with time acting as an intermediary. Here, the above operation includes varying the rotation frequency of the wafer, varying the traveling speed of the nozzle in the direction parallel to the wafer, varying the output of the ultrasonic wave, and varying the distance between the nozzle and the cleaning liquid collision spot concerned.

A cleaning liquid collision spot (or a nozzle) actually has a certain size. Therefore, taking the size into consideration, it is possible to select a certain point in the cleaning liquid collision spot (or a certain point on the nozzle), as a position of the cleaning liquid collision spot (or a nozzle position) when determining the position on the wafer. Normally, the center of the cleaning liquid collision spot (or the injection tip of the nozzle) may be selected.

When it is possible to vary the rotation frequency of the wafer correspondingly to the position of the cleaning liquid collision spot on the wafer, it is possible, for example, to decrease the rotation frequency of the wafer, in proportion as the cleaning liquid collision spot moves away from the rotation center of the wafer (or conversely, the rotation frequency of the wafer can be increased in proportion as the cleaning liquid collision spot comes nearer to the rotation center of the wafer). Further, it may also be possible to set the spin cleaning apparatus so as to automatically perform such operations. To vary the rotation frequency of the wafer automatically, it is possible to apply an arbitrary known art appropriately.

It was found that it is possible to improve the phenomenon that the breakage of fine structures occurs more frequently at a position nearer to the center of the wafer, by varying the rotation frequency of the wafer correspondingly to the position of the cleaning liquid collision spot, so as to increase the rotation frequency of the wafer when the cleaning liquid collision spot is positioned nearer to the rotation center of the wafer.

It is to be noted that, even if the rotation frequency of the wafer is varied, there is no change in the accumulated value of periods during which a certain point on the wafer surface stays in the cleaning liquid collision spot, on the basis of a given period. However, a period during which the point stays once in the cleaning liquid collision spot certainly varies.

As will be described later, “to make uniform the periods during which points on the wafer surface stay in the cleaning liquid collision spot, respectively” according to the present invention should be, in some cases, considered as “to make uniform the accumulated values of periods during which points on the wafer surface stay in the cleaning liquid collision spot, respectively”. However, regarding the change of the rotation frequency of the wafer, it may be proper to consider it as “to make uniform periods during each of which a point on the wafer surface stays once in the cleaning liquid collision spot”.

It can be easily determined how and to what extent the rotation frequency of the wafer should be varied, through experiments, etc., observing to what extent the occurrence of fine structure breakage on the wafer can be avoided.

When it is possible to vary the traveling speed of the nozzle in the direction parallel to the wafer correspondingly to the position of the cleaning liquid collision spot on the wafer, it is possible, for example, to decrease the traveling speed of the cleaning liquid collision spot in the direction parallel to the wafer, in proportion as the cleaning liquid collision spot moves away from the rotation center of the wafer. (Or, conversely, the traveling speed can be increased in proportion as the cleaning liquid collision spot comes nearer to the rotation center of the wafer.) Further, it may also be possible to set the spin cleaning apparatus so as to automatically perform such operations. Using the above-mentioned methods, it is possible to improve the aforementioned phenomenon that “a point on the wafer stays for a longer time in the cleaning liquid collision spot, in proportion as the point is positioned nearer to the center of the wafer”, and it is possible to “make uniform the accumulated values of periods during which points on the wafer surface stay in the cleaning liquid collision spot, respectively”. It is also possible to appropriately apply arbitrary known technologies to automatically change the traveling speed of the cleaning liquid collision spot.

It can be easily determined how and to what extent the above traveling speed should be varied, through experiments, etc., observing to what extent the occurrence of fine structure breakage on the wafer can be avoided.

When it is possible to vary the output of the ultrasonic wave correspondingly to the position of the cleaning liquid collision spot on the wafer, it is possible, for example, to increase the output of the ultrasonic wave, in proportion as the cleaning liquid collision spot moves away from the rotation center of the wafer. (Or, conversely, the output of the ultrasonic wave can be decreased in proportion as the cleaning liquid collision spot comes nearer to the rotation center of the wafer.) Further, it may also be possible to set the spin cleaning apparatus so as to automatically perform such operations. Additionally, in order to vary the output of the ultrasonic wave automatically, it is possible to apply an arbitrary known art appropriately.

With the above-mentioned method, it is possible to restrict the breakage of the fine structures on the wafer caused by excessive irradiation with the ultrasonic wave, even at the time of the occurrence of the aforementioned phenomenon that “a point on the wafer stays for a longer time in the cleaning liquid collision spot, in proportion as the point is positioned nearer to the center of the wafer”. Further, when the cleaning liquid collision spot is located at a position in which the linear movement of the cleaning liquid collision spot temporarily stops, such as the center of the wafer shown before, it is possible to set the spin cleaning apparatus so as to reduce the accumulated irradiation energy of the ultrasonic wave, by decreasing the output of the ultrasonic wave oscillator. Thus, it is possible to “make uniform the accumulated values of periods during which points on the wafer surface stay in the cleaning liquid collision spot, respectively”.

It can be easily determined how and to what extent the output of the ultrasonic wave should be varied, through experiments, etc., observing to what extent the occurrence of fine structure breakage on the wafer can be avoided.

Here, “the output of the ultrasonic wave” in this case means an accumulated value thereof during an arbitrary length of time. Therefore, to vary the output of the ultrasonic wave, it is possible to vary the output itself, or adjust an output on/off time.

The method of varying the ultrasonic wave output by adjusting the ON/OFF time of the ultrasonic wave output is useful particularly when the cleaning liquid collision spot is positioned at a location in which the cleaning liquid collision spot is moving with a significantly small linear velocity of movement, as compared with the other points on the wafer, since it is possible to have an OFF time of the ultrasonic wave output, correspondingly to the location. Such a case typically occurs when the cleaning liquid collision spot momentarily stays stationary on the wafer, due to the allowance present in the mechanical structure. Even in such a case, since the cleaning liquid collision spot has a certain level of expanse, it is not difficult to secure a proper amount of ultrasonic wave irradiation at the position concerned.

When it is possible to vary the distance between the nozzle and the cleaning liquid collision spot, correspondingly to the position of the cleaning liquid collision spot on the wafer, it is possible, for example, to decrease the distance between the nozzle and the cleaning liquid collision spot, in proportion as the cleaning liquid collision spot moves away from the rotation center of the wafer (or conversely, the distance between the nozzle and the cleaning liquid collision spot can be increased in proportion as the cleaning liquid collision spot comes nearer to the rotation center of the wafer). Further, it may also be possible to set the spin cleaning apparatus so as to automatically perform such operations. Additionally, in order to vary the distance between the nozzle and the cleaning liquid collision spot, it is possible to apply an arbitrary known art appropriately.

When the distance between the nozzle and the cleaning liquid collision spot is decreased, the ultrasonic wave produces a larger influence upon the wafer. On the other hand, when the distance between the nozzle and the cleaning liquid collision spot is increased, the ultrasonic wave energy attenuates, producing less influence on the wafer. Therefore, using the above-mentioned method, it is possible to restrict the breakage of the fine structures on the wafer caused by excessive irradiation with the ultrasonic wave, even in the occurrence of the aforementioned phenomenon that “a point on the wafer stays for a longer time in the cleaning liquid collision spot, in proportion as the point is positioned nearer to the center of the wafer”. Further, even when the cleaning liquid collision spot is located at a position in which the movement of the cleaning liquid collision spot temporarily stops, such as the center of the wafer, the accumulated irradiation energy of the ultrasonic wave can be reduced by increasing the distance between the nozzle and the wafer surface so as to attenuate the ultrasonic energy reaching the wafer surface. Thus, it is possible to “make uniform the accumulated values of periods during which points on the wafer surface stay in the cleaning liquid collision spot, respectively”.

It can be easily determined how and to what extent the above-mentioned distance should be varied by observing to what extent the occurrence of fine structure breakage on the wafer can be avoided, through experiments or other means.

The distance between the nozzle and the cleaning liquid collision spot can be varied either by varying the distance between the nozzle and the wafer surface, or by adjusting the elevation angle of the nozzle at the cleaning liquid collision spot (that is, when viewing from the wafer surface, an angle formed between a visual line and the wafer surface at the time the line connecting the nozzle and the cleaning liquid collision spot coincides with the visual line).

The former case is useful because the structure and the effect of the moving mechanism are simple. In the latter case, the structure is rather complicated, because a swing mechanism of the nozzle is necessary. However, when the ultrasonic wave is irradiated obliquely, the area of the cleaning liquid collision spot increases, which relatively decreases the amount of ultrasonic wave irradiation per unit area. Accordingly, a larger effect can be obtained as compared with the method of simply increasing the distance between the nozzle and the cleaning liquid collision spot. Further, in a case in which the cleaning liquid collision spot is located at a position having a significantly small linear velocity in the movement of the cleaning liquid collision spot, as compared with the other points on the wafer, such as the case of the above-mentioned positions where the cleaning liquid collision spot is stationary, it is possible to prevent the relevant position from being exposed to the ultrasonic wave irradiation for a long time, by greatly varying the direction of the nozzle.

Among the aforementioned conditions, it is preferable to have at least two functions out of the above functions (1) to (4), because a greater effect can be obtained. Since the above function (3) and (4) produce a large effect even when applied independently, it is more preferable to have at least one function out of (3) and (4). It is still more preferable to have one function out of the above (1) and (2), as well as one of the above (3) and (4).

Similarly, among the aforementioned conditions, it is preferable to perform at least two of the above actions (A) to (D), because a greater effect can be obtained. The above action (C) and (D) produce a large effect even when applied independently. Therefore, it is more preferable to have at least one action out of (C) and (D). Further, it is still more preferable to have one of the above (A) and (B), as well as one of (C) and (D).

It is to be noted that, in the cleaning technique using injection of only a cleaning liquid onto a wafer surface, there are known techniques for varying the traveling speed of a nozzle and for varying the rotation speed of the wafer, in proportion as the position thereof moves away from the center of the wafer in the radius direction {refer to Japanese Unexamined Patent Application Publication No. Sho 56-125842 (claims) and Japanese Unexamined Patent Application Publication No. Hei 01-076724 (claims)}. However, according to the present invention, use of both an ultrasonic wave and a cleaning liquid at the same time is an essential condition. In the case of using both the ultrasonic wave and the cleaning liquid, the effects of varying the rotation frequency of the wafer and varying the traveling speed of the nozzle in the direction parallel to the wafer, correspondingly to the position of the cleaning liquid collision spot on the wafer, have not been known to date.

It is considered that the effects obtained when injecting only a cleaning liquid onto the wafer surface are caused by a varied amount of the injection of the cleaning liquid. In contrast, when using both the ultrasonic wave and the cleaning liquid, it has been found that the cleaning effect produced by varying the amount of the cleaning liquid is not large; that use of only the cleaning liquid produces extremely lower cleaning capability than use of both the ultrasonic wave and the cleaning liquid at the same time; use of cleaning liquid only does not produce such a remarkable effect as “those obtained by varying the rotation frequency of the wafer, and varying the traveling speed of the nozzle in the direction parallel to the wafer, correspondingly to the position of the cleaning liquid collision spot on the wafer”, in the case in which both the ultrasonic wave and the cleaning liquid are used at the same time. Accordingly, it is considered that the effect by the present invention is mainly brought about by controlling the cleaning effect using the ultrasonic wave, and that the contribution to the cleaning effect by the cleaning liquid is small, if any.

### EXAMPLES

Next, examples and a comparative example according to the present invention will be described in detail. The following examples describe the effects obtained by using a spin cleaning apparatus that is one embodiment of the present invention, in order to clean wafers having fine patterns formed on the surface, as a typical example of fine structures. The common conditions are shown below:

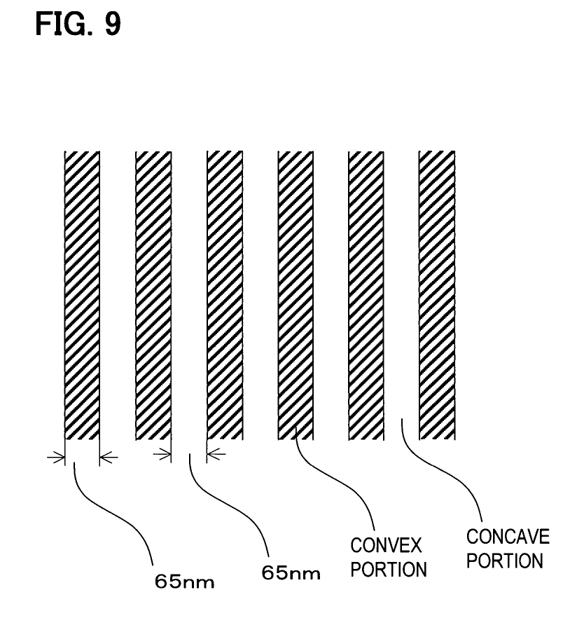

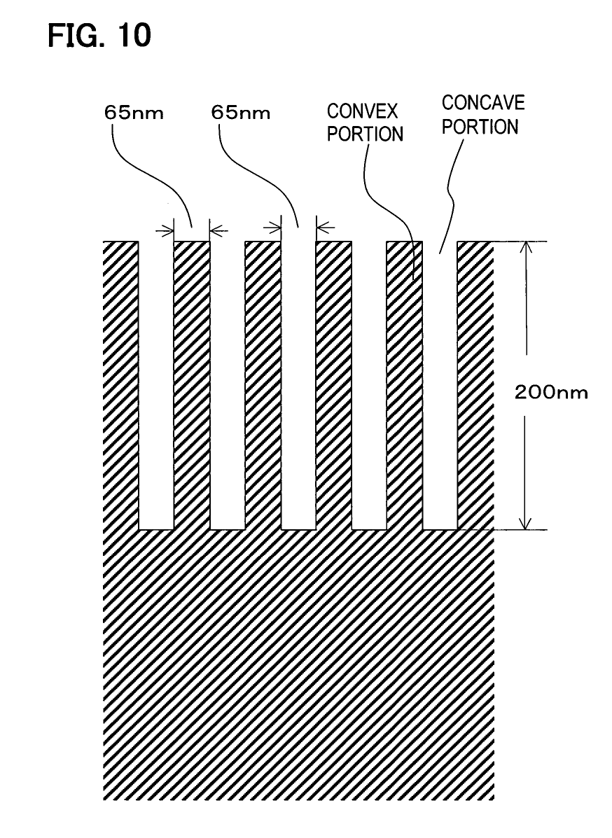

A film was formed on a Si-wafer having a diameter of 8 inches (approximately 200 mm), with an oxide insulating material in a uniform film thickness of 200 nm. On the insulating material film, a stripe-shaped uniform pattern of which L/S (line/space)=65/65 nm was formed through dry etching. The pattern depth was approximately 200 nm. The pattern is schematically depicted in FIGS. 9, 10. In the following examples, all the cleaning experiments were performed using the samples conforming to the above conditions.

Ultrasonic wave cleaning was performed for the above samples, using a spin cleaning apparatus. The following conditions were adopted as the standard conditions common to the examples and comparative example unless otherwise specified.

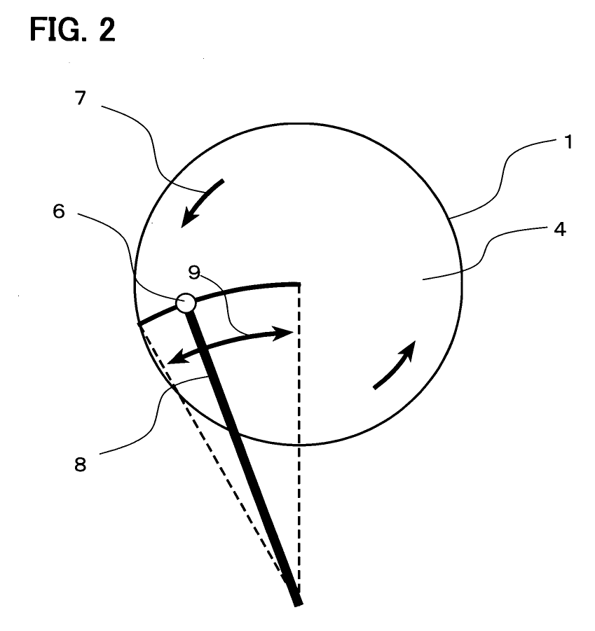

As a cleaning liquid to be injected from the nozzle, ultrapure water was used, and the injection flow rate thereof was set constantly at 1.5 L/min. The injection tip of the nozzle was perpendicularly directed at the wafer surface, and the cleaning liquid collision spot reciprocated, as shown in FIG. 2. The cleaning liquid collision spot was of a round shape with a diameter on the order of 2 mm. The traveling speed of the cleaning liquid collision spot was set at 50 mm/sec.

Regarding the conditions of the ultrasonic wave for irradiation, the frequency was set at 1 MHz with an output power of 60 W. The sample wafer was rotated at a constant speed of 500 revolutions/min (rpm). The distance between the nozzle tip (injection tip) and the wafer surface was set at 10 mm. The cleaning time was set at a constant value of 60 sec per wafer.

After the cleaning, using a wafer defect inspection apparatus, the relationship between the positions on the wafer and the occurrence frequency of the breakage of the fine structures was examined. A position on the wafer was represented by a distance r (mm) from the center of the wafer. Also, the occurrence frequency of the pattern breakage was represented by the occurrence density D of pattern breakage per unit area (number of pieces/mm²). As typical examples of broken patterns, column-shaped patterns having been bent, and patterns having been lost as a result of the breakage, are enumerated.

### Comparative Example 1

The cleaning was performed under the above-mentioned standard conditions, with the nozzle moving so that the cleaning liquid collision spot reciprocated at a constant speed in the range of 0≦r≦100. Here, the cleaning liquid collision spot stayed stationary for 0.3 sec at the positions of r=100 and r=0 at which the direction of movement was reversed, due to the allowance present in the mechanical structure for moving the nozzle.

The pattern inspection result after the cleaning is shown in Table 1. From the circumference of the wafer toward the center, the number of pattern breakages increased. Among them, an extremely large number of breakages were produced at the center.

Next, cleaning was performed by reciprocating the cleaning liquid collision spot in the range of 30≦r≦100. The result of the pattern inspection is shown in Table 2. In this case also, the number of pattern breakages increased from the circumference of the wafer toward the center, and at the position of r=30, at which the movement direction of the cleaning liquid collision spot was reversed, a prominently large number of pattern breakages were produced. In the range of 0≦r≦30, no pattern breakage occurred because of no ultrasonic wave irradiation.

### Example 1

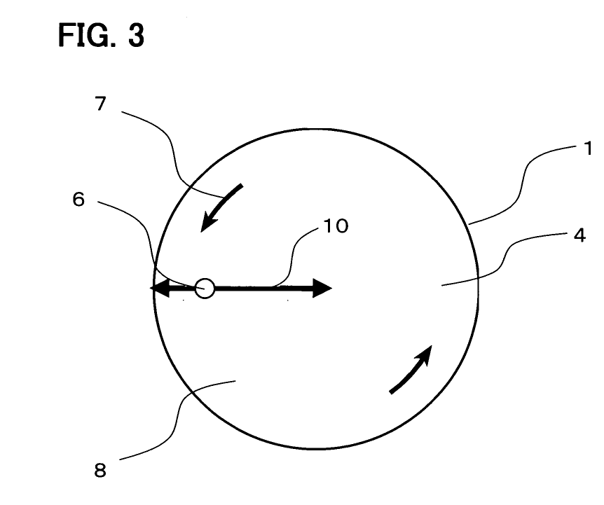

Then, cleaning similar to the above description was performed under the following settings, utilizing a function according to the present invention, i.e. a function capable of automatically setting the ultrasonic wave at ON/OFF, correspondingly to the position of the cleaning liquid collision spot. That is, the ultrasonic wave was set at OFF only at the positions where the movement direction of the cleaning liquid collision spot was reversed. More specifically, the cleaning was performed under the following conditions: the ultrasonic wave was made OFF for 0.3 sec in synchronization with the stationary period of the cleaning liquid collision spot, that is, only at the positions of r=0 and r=100 in the case in which the range of movement of the cleaning liquid collision spot was 0≦r≦100, and only at the positions of r=30 and r=100 in the case in which the range of movement of the cleaning liquid collision spot was 30≦r≦100. The results of pattern inspection are shown in FIG. 3 for the case of 0≦r≦100, and in FIG. 4 for the case of 30≦r≦100, respectively. In both cases, by making the ultrasonic wave OFF at the positions where the cleaning liquid collision spot became stationary, the numbers of pattern breakages produced at the positions were remarkably reduced.

### Example 2

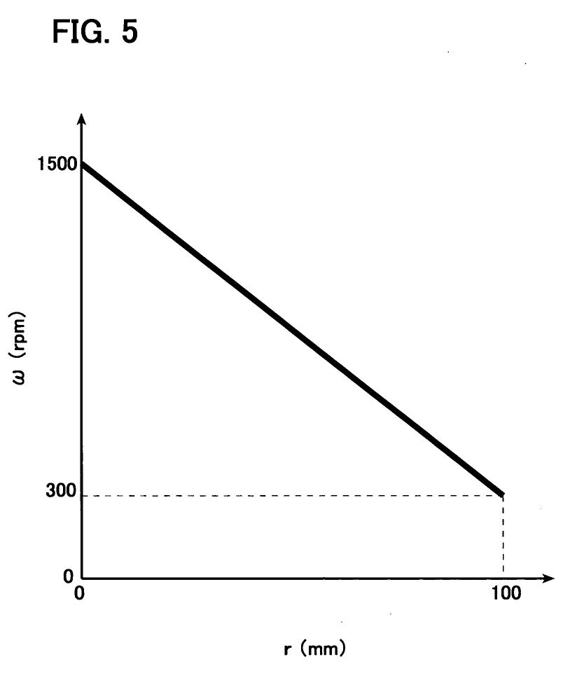

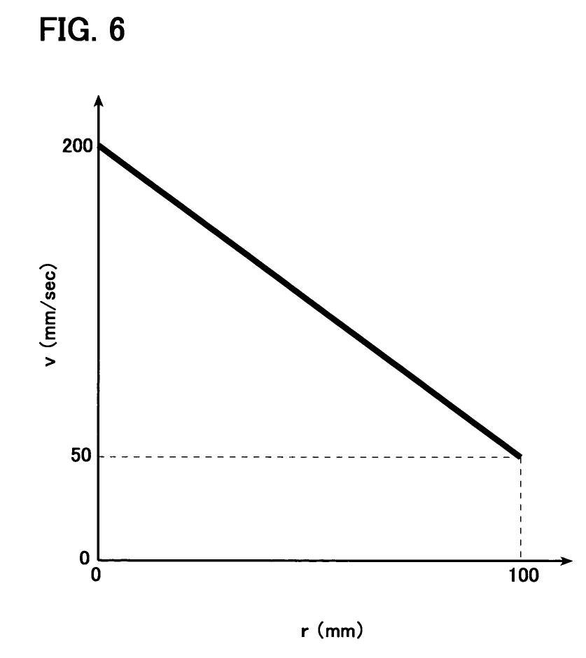

Next, utilizing a function capable of automatically varying the rotation frequency of the wafer according to the present invention, correspondingly to the position of the cleaning liquid collision spot, the setting was made so that the sample wafer was rotated at a faster speed where the cleaning liquid collision spot was located at the position nearer to the center of the wafer. Also, utilizing a function capable of automatically varying the traveling speed of the nozzle correspondingly to the position of the cleaning liquid collision spot, the setting was made so that the cleaning liquid collision spot was reciprocated at a faster speed where the cleaning liquid collision spot was located at the position nearer to the center of the wafer. Specifically, the settings were made, respectively, so that the relationship between the nozzle position r (which coincides with the position of the cleaning liquid collision spot) and the rotation frequency ω of the wafer had the relationship shown in FIG. 5, and that the relationship between the nozzle position r and the traveling speed v of the nozzle (which coincides with the traveling speed of the cleaning liquid collision spot) had the relationship shown in FIG. 6.

Under the above settings, the cleaning was performed while the ultrasonic wave was continued to be ON. The results of the pattern inspection were shown in Table 5 for the case of 0≦r≦100, and in Table 6 for the case of 30≦r≦100, respectively. Because the irradiation with the ultrasonic wave was continued, a large number of pattern breakages were produced at the positions of r=0 and r=30 at which the cleaning liquid collision spot became stationary. However, other pattern breakages, which had increased gradually in proportion as the position came nearer to the center, were no more produced.

The reason is considered to be a complex effect caused by the two settings performed in this example: one effect produced by reducing the period during which a point on the wafer surface stays once in the cleaning liquid collision spot at a position having a smaller linear movement velocity of the cleaning liquid collision spot (that is, an effect of increasing the rotation speed of the wafer), as compared with the other points on the wafer; and another effect produced by reducing the accumulated value of periods during which a point on the wafer surface stays in the cleaning liquid collision spot (that is, an effect produced by increasing the traveling speed of the cleaning liquid collision spot).

### Example 3

Next, cleaning was performed, simultaneously applying the settings of the ultrasonic wave at ON/OFF, the rotation speed of the wafer, and the traveling speed of the cleaning liquid collision spot, corresponding to the position of the cleaning liquid collision spot, each having been applied in examples 1 and 2.

The result of pattern inspection regarding the case of 0≦r≦100 is shown in Table 7. No breakage of pattern was produced any more.

Furthermore, experiments were performed in which fine particles were attached intentionally onto the surface of the wafer on which no patterns had been formed, and then cleaning was performed to remove the fine particles. As a result, it was confirmed that, as compared with the cleaning without the settings of this example, the cleaning under the settings of this example provided the same level of removal capability of the fine particles.

### Example 4

In example 1, the ultrasonic wave was set at OFF for the purpose of preventing one the same point on the wafer from being exposed for a long time to the irradiation of the ultrasonic wave, either when the cleaning liquid collision spot was located at a position in which the cleaning liquid collision spot had an extremely small linear movement velocity (i.e. the traveling speed), as compared with the other points on the wafer, or when the cleaning liquid collision spot was stationary. However, means for achieving the same purpose are not limited to the above.

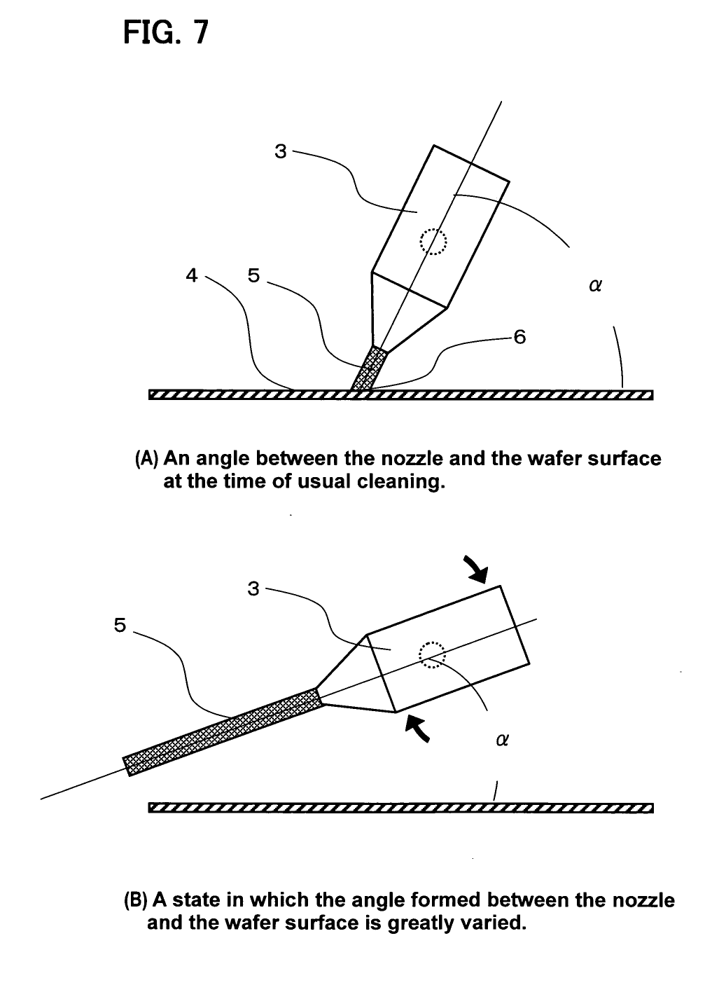

For example, as shown in FIG. 7, it may be possible to avoid damage on the pattern by making the elevation angle α of the nozzle variable at the cleaning liquid collision spot; retaining the nozzle in a state to produce a certain angle as shown in (a) during performing the cleaning, and then, greatly varying the elevation angle of the nozzle at the cleaning liquid collision spot as shown in (b), only at the position where the ultrasonic wave is set at OFF in the case of the above example 1.

Cleaning was performed in a similar way to example 3, except for adopting the method shown in this example, instead of the method adopted in example 1. As a result, it was possible to clean the wafer without producing pattern breakage, a result similar to that shown in Table 7.

### Example 5

In example 2, the traveling speed of the cleaning liquid collision spot was varied for the purpose of making a point on the wafer stay in the cleaning liquid collision spot for a shorter time at a location where the linear velocity of the cleaning liquid collision spot was small as compared with the other points on the wafer. However, means for achieving the same purpose are not limited to the above.

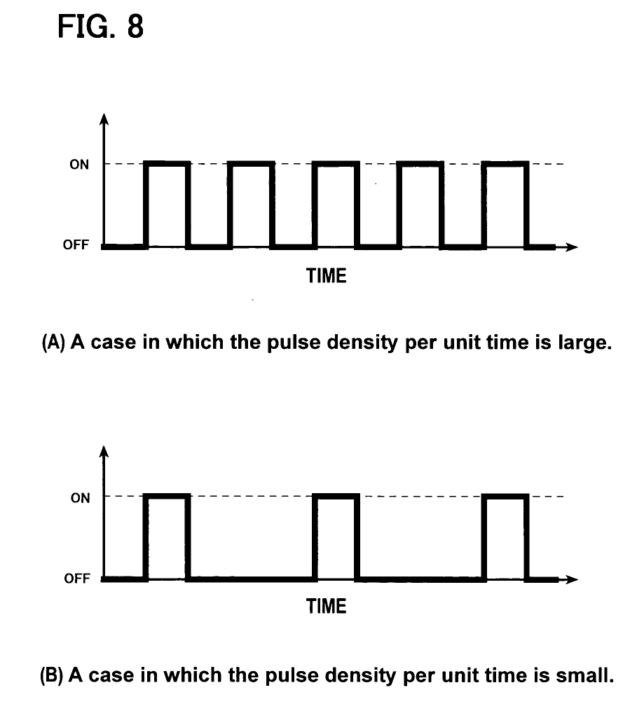

For example, as shown in FIG. 8, the same purpose can be achieved by making the ultrasonic wave ON/OFF repeatedly at a high speed, thereby irradiating the wafer with a pulse-shaped ultrasonic wave; and further, varying the time intervals of the pulses i.e. the pulse density per unit time, correspondingly to the position of the cleaning liquid collision spot, since the irradiation energy of the ultrasonic wave per unit time is varied.

By making it possible to irradiate a ultrasonic wave in a pulse shape, while such irradiation is continuous in the conventional method, setting the pulse length (the ON time length) at 100 msec, and varying the number of pulses produced per second between 0 and 5, correspondingly to the position of the cleaning liquid collision spot, it was possible to clean the wafer without producing pattern breakage, a result similarly to that shown in Table 7. Specifically, where r=0 mm, the number of pulses per second was set at 0 for the above stationary period of 0.3 sec. Thereafter, the number of pulses was monotonously increased to 5 in a range of up to r=90 mm.

### Example 6

Further, it is also possible to achieve the same purpose by varying the output of the ultrasonic wave oscillator correspondingly to the position of the cleaning liquid collision spot, in place of the means applied in the method shown in example 5.

In the conventional method, an ultrasonic wave signal output sent to the ultrasonic wave vibrator from the ultrasonic wave oscillator was fixed to 60 W. In contrast, the output was varied from 0 W through 60 W correspondingly to the position of the cleaning liquid collision spot. As a result, similarly to the result shown in Table 7, it was possible to clean the wafer without producing pattern breakage. Specifically, where r=0 mm, the power was held at 0 W for the above stationary period of 0.3 sec, and thereafter, the power was monotonously increased to 60 W in a range of up to r=90 mm.

### Example 7

Furthermore, it is also possible to achieve the same purpose by varying the distance between the nozzle and the wafer surface, correspondingly to the position of the cleaning liquid collision spot, in place of the method shown in example 5. This example utilizes the fact that the ultrasonic wave energy attenuates in proportion as the distance from the nozzle tip increases.

The distance between the nozzle and the wafer surface may be varied, for example, by vertically moving the axle of the supporting point for the arm, to directly move the nozzle motion plane vertically. Or, the above distance may be varied by tilting the motion plane of the nozzle against the wafer surface, leaving the motion plane thereof in a straight shape.

In contrast to the conventional method of a fixed distance between the nozzle tip and the wafer surface of 10 mm, it was possible to clean the wafer without producing pattern breakage, a result similar to that shown in Table 7, by varying the above distance in a range of from 10 mm to 45 mm. Specifically, where r=0 mm, the distance was held at 45 mm for the above stationary period of 0.3 sec, and thereafter, the distance was monotonously decreased to 10 mm, in a range of up to r=90 mm.

Here, according to the above example, the distance between the nozzle and the cleaning liquid collision spot was varied by varying the distance between the nozzle tip and the wafer surface. To compare, the variation of the elevation angle shown in example 4 produces an effect of varying the distance between the nozzle and the cleaning liquid collision spot, without varying the distance between the nozzle tip and the wafer surface. Therefore, it may also be possible to combine the method of this example with the method of varying the elevation angle.

TABLE 1
Cleaning result without using the method of
the present invention (0 ≦ r ≦ 100)

| | r (mm) | | | | | | | | | | |
|---|---|---|---|---|---|---|---|---|---|---|---|
| | 0 | 10 | 20 | 30 | 40 | 50 | 60 | 70 | 80 | 90 | 100 |
| D (pcs/sq. mm) | 51172 | 9863 | 4605 | 3130 | 1881 | 926 | 506 | 92 | 5 | 0 | 0 |

TABLE 2
Cleaning result without using the method of
the present invention (30 ≦ r ≦ 100)

| | r (mm) | | | | | | | | | | |
|---|---|---|---|---|---|---|---|---|---|---|---|
| | 0 | 10 | 20 | 30 | 40 | 50 | 60 | 70 | 80 | 90 | 100 |
| D (pcs/sq. mm) | 0 | 0 | 0 | 19768 | 3311 | 1409 | 684 | 322 | 89 | 6 | 0 |

TABLE 3
Cleaning result when the ultrasonic wave was
set at OFF at the point where the irradiation spot was
stationary (0 ≦ r ≦ 100)

| | r (mm) | | | | | | | | | | |
|---|---|---|---|---|---|---|---|---|---|---|---|
| | 0 | 10 | 20 | 30 | 40 | 50 | 60 | 70 | 80 | 90 | 100 |
| D (pcs/sq. mm) | 17154 | 10382 | 5501 | 3466 | 2590 | 1508 | 997 | 583 | 32 | 0 | 0 |

TABLE 4
Cleaning result when the ultrasonic wave was
set at OFF at the point where the irradiation spot was
stationary (30 ≦ r ≦ 100)

| | r (mm) | | | | | | | | | | |
|---|---|---|---|---|---|---|---|---|---|---|---|
| | 0 | 10 | 20 | 30 | 40 | 50 | 60 | 70 | 80 | 90 | 100 |
| D (pcs/sq. mm) | 0 | 0 | 0 | 4012 | 3522 | 2143 | 1206 | 948 | 750 | 581 | 0 |

TABLE 5
Cleaning result when both the wafer rotation
frequency and the nozzle traveling speed were varied
(0 ≦ r ≦ 100)

| | r (mm) | | | | | | | | | | |
|---|---|---|---|---|---|---|---|---|---|---|---|
| | 0 | 10 | 20 | 30 | 40 | 50 | 60 | 70 | 80 | 90 | 100 |
| D | 31842 | 0 | 0 | 0 | 0 | 0 | 0 | 0 | 0 | 0 | 0 |
| (pcs/sq. mm) | | | | | | | | | | | |

TABLE 6
Cleaning result when both the wafer rotation
frequency and the nozzle traveling speed were varied
(30 ≦ r ≦ 100)

| | r (mm) | | | | | | | | | | |
|---|---|---|---|---|---|---|---|---|---|---|---|
| | 0 | 10 | 20 | 30 | 40 | 50 | 60 | 70 | 80 | 90 | 100 |
| D | 0 | 0 | 0 | 15811 | 0 | 0 | 0 | 0 | 0 | 0 | 0 |
| (pcs/sq. mm) | | | | | | | | | | | |

TABLE 7
Cleaning result when using the ultrasonic wave
set at OFF, together with variation of the wafer rotation
frequency and the nozzle traveling speed (0 ≦ r ≦ 100)

| | r (mm) | | | | | | | | | | |
|---|---|---|---|---|---|---|---|---|---|---|---|
| | 0 | 10 | 20 | 30 | 40 | 50 | 60 | 70 | 80 | 90 | 100 |
| D (pcs/sq. mm) | 0 | 0 | 0 | 0 | 0 | 0 | 0 | 0 | 0 | 0 | 0 |

What is claimed is:

1. A spin cleaning apparatus for cleaning a wafer surface by rotating the wafer to be cleaned, injecting a cleaning liquid from a nozzle onto the wafer surface while moving the nozzle, and at the same time, with an ultrasonic wave generated inside the nozzle, irradiating a cleaning liquid collision spot, a point of the wafer surface with which the cleaning liquid injected from the nozzle collides, via the cleaning liquid in the capacity of an intermediary, said spin cleaning apparatus comprising at least one of the functions of:
varying the rotation frequency of the wafer, correspondingly to the position of the cleaning liquid collision spot on the wafer;
varying the traveling speed of the nozzle in the direction parallel to the wafer, correspondingly to the position of the cleaning liquid collision spot on the wafer;
varying the output of the ultrasonic wave, correspondingly to the position of the cleaning liquid collision spot on the wafer; and
varying the distance between the nozzle and the cleaning liquid collision spot, correspondingly to the position of the cleaning liquid collision spot on the wafer.

2. The spin cleaning apparatus according to claim 1, comprising at least two of said functions.

3. The spin cleaning apparatus according to claim 1, further comprising:
at least one of the function of varying the output of the ultrasonic wave, correspondingly to the position of the cleaning liquid collision spot on the wafer and the function of varying the distance between the nozzle and the cleaning liquid collision spot, correspondingly to the position of the cleaning liquid collision spot on the wafer.

4. The spin cleaning apparatus according to claim 1, further comprising:
at least one of the function of varying the output of the ultrasonic wave, correspondingly to the position of the cleaning liquid collision spot on the wafer and the function of varying the distance between the nozzle and the cleaning liquid collision spot, correspondingly to the position of the cleaning liquid collision spot on the wafer; and
at least one of the function of varying the rotation frequency of the wafer, correspondingly to the position of the cleaning liquid collision spot on the wafer and the function of varying the traveling speed of the nozzle in the direction parallel to the wafer, correspondingly to the position of the cleaning liquid collision spot on the wafer.

5. The spin cleaning apparatus according to claim 1, further comprising the capability of setting the rotation frequency of the wafer so as to decrease it in proportion as the cleaning liquid collision spot moves away from the center of the wafer.

6. The spin cleaning apparatus according to claim 1, further comprising the capability of setting the traveling speed of the cleaning liquid collision spot in the direction parallel to the wafer so as to decrease it in proportion as the cleaning liquid collision spot moves away from the center of the wafer.

7. The spin cleaning apparatus according to claim 1, further comprising the capability of setting the output of the ultrasonic wave so as to increase it in proportion as the cleaning liquid collision spot moves away from the center of the wafer.

8. The spin cleaning apparatus according to claim 1, further comprising the capability of setting the output of the ultrasonic wave so as to realize a varied output of the ultrasonic wave by adjusting an on/off time of the output of the ultrasonic wave.

9. The spin cleaning apparatus according to claim 1, further comprising the capability of setting the distance between the nozzle and the cleaning liquid collision spot so as to decrease it in proportion as the cleaning liquid collision spot moves away from the center of the wafer.

10. The spin cleaning apparatus according to claim 1, further comprising the capability of setting the elevation angle of the nozzle so as to vary the distance between the nozzle and the cleaning liquid collision spot, by varying the elevation angle of the nozzle at the cleaning liquid collision spot.

11. The spin cleaning apparatus according to claim 1, further comprising the capability of setting the distance between the nozzle and the wafer surface so as to vary the distance between the nozzle and the cleaning liquid collision spot, by varying the distance between the nozzle and the wafer surface.

12. A wafer cleaning method for cleaning a wafer surface by rotating the wafer to be cleaned, injecting a cleaning liquid from a nozzle onto the wafer surface while moving the nozzle, and at the same time, with an ultrasonic wave generated inside the nozzle, irradiating a cleaning liquid collision spot, a point of the wafer surface with which the cleaning liquid injected from the nozzle collides, via the cleaning liquid in the capacity of an intermediary, said wafer cleaning method comprising at least one of the actions of:
varying the rotation frequency of the wafer, correspondingly to the position of the cleaning liquid collision spot on the wafer;
varying the traveling speed of the nozzle in the direction parallel to the wafer, correspondingly to the position of the cleaning liquid collision spot on the wafer;
varying the output of the ultrasonic wave, correspondingly to the position of the cleaning liquid collision spot on the wafer; and
varying the distance between the nozzle and the cleaning liquid collision spot, correspondingly to the position of the cleaning liquid collision spot on the wafer.

13. The wafer cleaning method according to claim 12, comprising at least two of the actions stated in claim 12.

14. The wafer cleaning method according to claim 12, comprising at least one of the action of varying the output of the ultrasonic wave, correspondingly to the position of the cleaning liquid collision spot on the wafer and the action of varying the distance between the nozzle and the cleaning liquid collision spot, correspondingly to the position of the cleaning liquid collision spot on the wafer.

15. The wafer cleaning method according to claim 12, further comprising:
at least one of the action of varying the output of the ultrasonic wave, correspondingly to the position of the cleaning liquid collision spot on the wafer and the action of varying the distance between the nozzle and the cleaning liquid collision spot, correspondingly to the position of the cleaning liquid collision spot on the wafer; and
at least one of the action of varying the rotation frequency of the wafer, correspondingly to the position of the cleaning liquid collision spot on the wafer and the action of varying the traveling speed of the nozzle in the direction parallel to the wafer, correspondingly to the position of the cleaning liquid collision spot on the wafer.

16. The wafer cleaning method according to claim 12, further comprising:
decreasing the rotation frequency of the wafer, in proportion as the cleaning liquid collision spot moves away from the center of the wafer.

17. The wafer cleaning method according to claim 12, further comprising:
decreasing the traveling speed of the cleaning liquid collision spot in the direction parallel to the wafer, in proportion as the cleaning liquid collision spot moves away from the center of the wafer.

18. The wafer cleaning method according to claim 12, further comprising:
increasing the output of the ultrasonic wave, in proportion as the cleaning liquid collision spot moves away from the center of the wafer.

19. The wafer cleaning method according to claim 12, further comprising:
realizing a varied output of the ultrasonic wave by adjusting an on/off time of the output of the ultrasonic wave.

20. The wafer cleaning method according to claim 12, further comprising:
decreasing the distance between the nozzle and the cleaning liquid collision spot, in proportion as the cleaning liquid collision spot moves away from the center of the wafer.
